(19) United States
(12) Patent Application Publication
(10) Pub. No.: US 2022/0301364 A1
(43) Pub. Date: Sep. 22, 2022

(54) Driver and Passenger Behavior Information System

(71) Applicant: Decentralized Biotechnology Intelligence Co., Ltd., Taipei (TW)

(72) Inventors: Yen-Han CHOU, Taipei (TW); Yao-Sheng CHOU, Taipei (TW)

(21) Appl. No.: 17/696,841

(22) Filed: Mar. 16, 2022

(30) Foreign Application Priority Data
Mar. 22, 2021 (TW) 110110242

(51) Int. Cl. G07C 5/04; G07C 5/00; G06Q 40/08

(52) U.S. Cl. CPC G07C 5/04; G07C 5/008; G06Q 40/08

(57) ABSTRACT

The present invention provides a driver and passenger behavior information system which includes a sensing device to detect a driving behavior signal, wherein the sensing device is set at the vehicle control associated apparatus for controlling the vehicle and sensing the driving behavior signal by the sensing device, a driving behavior record device is coupled to the sensing device to store the sensing signals.

### CROSS-REFERENCE TO RELATED APPLICATIONS

The present application claims the benefit of TAIWAN Patent Application Serial Number 110110242 filed on Mar. 22, 2021, which is herein incorporated by reference.

### TECHNICAL FIELD

The present invention relates to a driving behavior information system, more specifically, a driving and driving behavior information system to collect driving and passenger behavior signals and analyze driving and passenger behavior through the steering wheel, cushion and backrest by sensing devices.

### BACKGROUND

Traffic safety has been an important issue for a long time. When traffic accidents occur, in addition to causing financial losses, family social human productivity decreases, and traffic accidents also account for a considerable proportion of fatal accidents. According to the statistics made by the Taiwan authority agency in 2020, the death caused by traffic accidents ranks sixth among the top ten causes of death in Taiwan, while the death caused by accident injury is the first cause of death in the range from one year old to 25 years old.

In traffic behaviors, traffic accidents directly or indirectly related to vehicle driving can be roughly divided into the following situations. One situation is improper driving behavior, such as poor driving trajectory when changing lanes, vehicle out of control caused by speeding, and failure to maintain a safe driving distance. The second situation is the poor mental state when driving, such as drunk driving and fatigue driving. In addition, lack of concentration leads to distraction in driving, such as not paying attention to the vehicle in front, pedestrians, road conditions and so on. However, from the perspective of others, these conditions can be observed through vehicle speed, accelerator pedal, turning trajectory, braking distance and braking response. Radical driving may have some improper driving behaviors or habits which results in a higher probability of accidents than others. In addition, professional drivers, such as bus, truck and taxi drivers, often cause traffic accidents due to bad spirit, excessive impatience and overconfidence.

In response to the above problems, ongoing research and experiments show that evaluating the driver's driving behavior and physiological condition through real-time monitoring and intelligent devices is helpful to early detect possible improper driving behavior or bad habits, so that the driving computer can actively intervene early and change the accelerator retraction and release, braking force, gear change timing, and even the turning track, or passively remind drivers to change their driving behaviors to avoid traffic accidents. The above bad habits or improper driving behaviors can also be recorded and statistically analyzed. In addition, if the driver is a professional driver, the company can also remotely manage some bad driving behaviors of drivers on the route. Therefore, in order to achieve the above purpose, in the existing research literature on driving behavior analysis, it can be further classified from the analysis of signal sources, which can be divided into two categories. One is the physiological signal analysis method using the driver's physiological signal and its derived state, and the other is the driving performance analysis method using the vehicle driving mode to analyze the driving signals.

Taking the above driving performance analysis method as an example, please refer to China patent Publication No. CN102167041A, which discloses a method for determining the driving state of a vehicle based on an acceleration sensor. The processing steps include: (1) using an acceleration sensor to detect the longitudinal acceleration, transverse acceleration and vertical acceleration of the vehicle; (2) calculating the conversion matrix between the vehicle coordinate system and the acceleration sensor coordinate system, to obtain the initial attitude of the acceleration sensor, that is, the initial angle between the acceleration sensor and the vehicle, so as to obtain the acceleration value of the vehicle coordinate system; (3) determining the driving state of the vehicle according to the acceleration values of several consecutive vehicle coordinate systems. In the '041 patent, it uses the above values via coordinate conversion by the acceleration sensor to determine the driving state of the vehicle, so as to understand the driving behavior and state of the driver.

However, the current human drivers will still dominate the control of vehicles for a considerable period of time in the future. The above analysis method by driving performance as traffic behavior can only indirectly obtain the information of improper driving behavior from the vehicle travelling path, such as vehicle out of control caused by speeding, failure to maintain driving safety distance and so on. It is impossible to judge the safety degree of driving behavior directly by the driver's driving habits or mental state, and to more effectively intervene in advance or warn the driver before bad driving behavior occurs. If we can evaluate the driver's driving condition before the accident and provide it to the police and government units, insurers or relevant management units (such as the management end of professional driving), we can further clarify the responsibility attribution before and after the traffic accident. Therefore, in today's market, there is still an urgent need for a driving system that can evaluate the driver's own condition.

### SUMMARY

In order to solve the above problems, the present invention proposes a driving and driver behavior information system comprising a sensing device for measuring driver (passenger) behavior signals. An analysis device is coupled with the sensing device to analyze the driver (driving) behavior according to the obtained driver behavior signal. A storage device (driving behavior recording device) stores driver (driving) behavior signals and/or analysis results. A control device can control the operation of the driving and driver behavior information system, and the control device can be a microcontroller unit (MCU). The control device can be integrated into the vehicle's built-in driving computer or externally connected to the driving computer. The above sensing devices are configured on vehicle control part (such as cushion, steering wheel, pedal in the vehicle), coupled with the control device, and transmits the driver (driving) behavior signal to the control device for data processing.

According to one aspect of the invention, the sensing device can be a capacitive sensing device or a resistive sensing device, which generates a sensing signal through the physical parameters applied by the driver when contacting the vehicle control part, and obtains the driver behavior signal of the driver operating the vehicle control part after comparing with a reference signal by a comparator contained in the sensing device. The capacitive sensing device mainly uses the principle of parallel capacitor plate. When the diaphragm on the sensing device deforms under pressure, the gap between the diaphragm and the bottom plate electrode changes to cause the change of capacitance, and the pressure can be sensed through the change of capacitance.

According to another aspect, the sensing device can also be set in the cushion and backrest of the vehicle to detect the riding conditions of driver and passengers. For example, when the road bounce is large or there is emergency braking behavior, it can detect the riding conditions, so as to provide driving and driver behavior information system to analyze the driving conditions.

According to one aspect of the invention, the analysis device includes a data processor, which establishes the analysis model of driving behavior by the relationship between the strength of the driver behavior signal and time. For example, the driver's grip strength on the steering wheel can be included in the analysis results by recording the average grip strength or grip position of the steering wheel during daily driving behavior. In an application scenario, when the grip strength is much greater than the average in a short time, the driving and driver behavior information system can judge that the driving behavior of the vehicle may have a high probability of abnormality, which can be used as the basis for the judgment of the analysis device.

According to one aspect of the invention, the analysis device comprises a classifier, which further classifies the analysis model established by the data processor. For example, the strength or position of the driver's grip on the steering wheel enables the analysis device to judge the driving state of driver at present in the normal driving situation, the driving situation of mental laxity and the driving situation when overtaking.

According to one aspect the invention, by obtaining the analysis results output by the storage device or the analysis device, the evaluation of insurance risk can be carried out through the insurance evaluation system of automobile companies or insurance companies to estimate the premium rate. Among them, the insurance business can include fleet management, behavioral vehicle insurance, insurance formulated based on customer usage or driving style, and further provide vehicle resume. In an embodiment of the invention, the insurance evaluation system can be installed on a remote cloud platform or the near end vehicle itself.

According to an embodiment of the invention, the driving and driver behavior information system comprises a vehicle smart device, which is coupled with the control device and provides the analysis results of the analysis device as the integration of other functions in the driving computer of the vehicle, for example, active vehicle-distance control, collision prevention, pedestrian detection and warning, moving object detection and warning, etc.

The above description is used to explain the purpose, technical means and the achievable effect of the invention. Those familiar with the technology in the relevant field can understand the invention more clearly through the following embodiments, the accompanying description of the drawings and claims.

### BRIEF DESCRIPTION OF THE DRAWINGS

The components, characteristics and advantages of the present invention may be understood by the detailed descriptions of the preferred embodiments outlined in the specification and the drawings attached:

FIG. 1 shows an example of a driving and driver behavior information system;

FIG. 2 shows another embodiment of a driving and driver behavior information system applied to a cloud platform;

FIG. 3 illustrates an analysis device and a control device applied to the cloud platform according to one embodiment;

FIG. 4 shows an application of a sensing device according to one embodiment;

FIG. 5 shows sensing devices configured on a steering wheel according to one embodiment;

FIG. 6 illustrates a sensing device configured on a pedal according to another embodiment.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The purpose of the invention is to improve the current analysis method by driving performance as traffic behavior, which can only indirectly obtain the improper driving behavior from the driving track (trajectory) after the driving behavior occurs, and cannot directly judge the safety degree of the driving behavior by the driver's own mental state. For example, even if the driving track is normal, the driver may have been distracted due to poor mental condition. However, the analysis method based on the driving track can only infer from the driving track afterwards, and cannot find the probability of traffic accidents in advance, and thereby missing the opportunity of early warning. Therefore, the driving conditions can be evaluated before the traffic accident, such as the force and depth of pedal (accelerator, brake, clutch), the holding strength (which may represent the tightness of the driver's mood) or position of steering wheel, and the pressure of seat cushion (indicating road conditions), and such conditions can be provided to the driving computer, police administration division and insurance companies, or relevant management terminals (such as the management terminal of professional driving), it can also further clarify the responsibility attribution before and after traffic accidents.

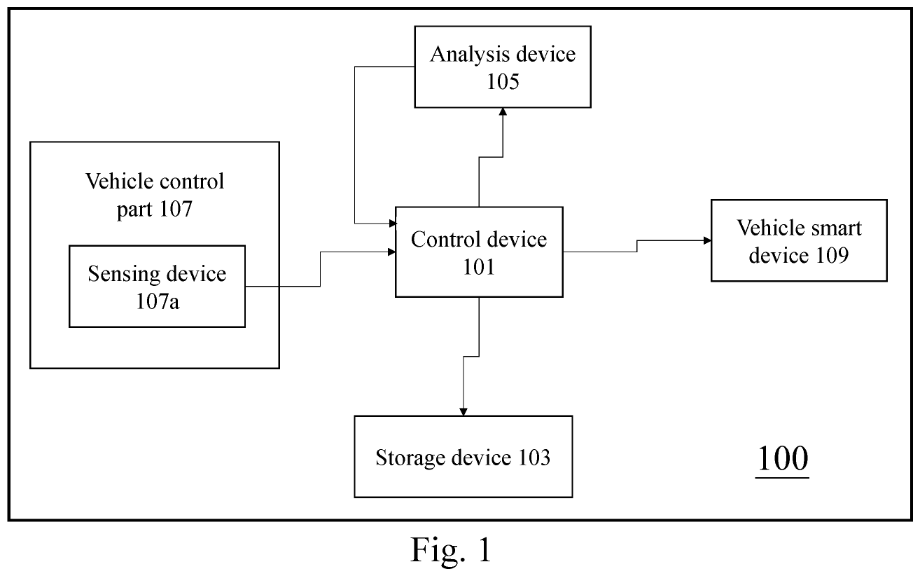

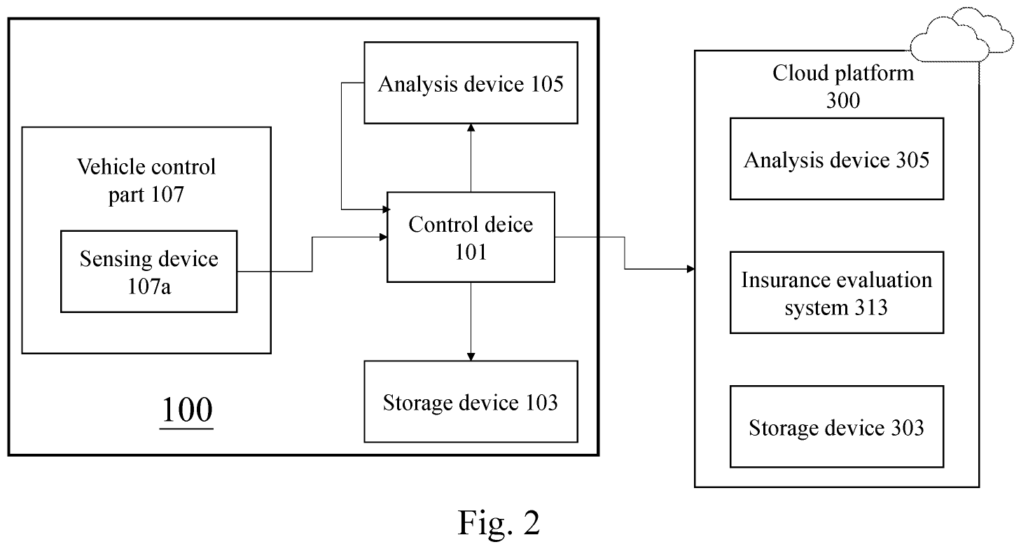

In order to achieve the above purpose, please refer to FIGS. 1-2. The invention proposes a driving and driver behavior information system 100 that comprises a sensing device 107a configured on a vehicle control part 107 to collect a driving behavior signal of driver. The sensing device 107a is coupled with a control device 101, which controls the operation of the driving and driver behavior information system 100, which can be integrated into a vehicle smart device 109 built in the vehicle. The driving parameters or signals are transmitted to the control device 101. The sensing device 107a is for example a resistive sensing device or a capacitive sensing device. As the sensing device 107a is a capacitive sensing device, the driver's behavior signal S_{dr} detected by the sensing device 107a is used as a variable. An analysis device 105 is coupled with the control device 101 to analyze the driver's driving behavior according to the obtained driving parameters or signals, and output an analysis result. A storage device 103 is used to store the analysis results of the analysis device 105. In one aspect of the invention, the sensing device 107a can measure the physical quantity of pressure. The driver's physiological and psychological state and driving behavior can be monitored in real time through the pressure change applied by the driver to the vehicle control part 107. For example, when the driver is distracted, the grip strength of the hand applied to a steering wheel 500 may be reduced or positioned improperly, or when the driver is out of control (such as malicious forcing, pedestrians disobeying traffic rules, or other vehicles jumping in line), the grip strength applied to the steering wheel 500 may deviate from the normal situation, so as to warn in advance or intervene in the control of the vehicle before traffic accidents or dangerous driving behaviors occur.

According to an embodiment of the invention, the sensing device 107a can also be arranged in the cushion and backrest of the vehicle to detect the riding conditions of driver and passengers. For example, when the road bounce is large or there is emergency braking behavior, it can detect the riding conditions, and provide the information to the driving and driver behavior information system 100 to analyze the driving conditions. In case of traffic accidents, dangerous driving, poor road conditions and other situations, it can warn or intervene in vehicle control.

As described above, in one aspect of the present invention, the vehicle control part 107 may be, but is not limited to, a control device that directly or indirectly controls the vehicle, such as a steering wheel 500, a pedal device 600, etc. Among them, at least one sensing device 107a can be set according to the real application. For example, as the sensing devices 107a are set in the steering wheel 500, they can be set in four quadrants with the center of the steering wheel 500 as the origin according to the current driving habits of the driver, such as upper right (first quadrant), upper left (second quadrant), lower left (third quadrant) and lower right (fourth quadrant), so as to ensure that the driver's hand can be accurately placed on the above orientation in the steering wheel 500 when driving, and the holding strength is measured through actually touching the sensing device 107a. At least one sensing device 107a is configured in each quadrant.

In one embodiment of the invention, the driving and driver behavior information system 100 usually includes a processing chip, a memory, a temporary storage memory, a display device, a network communication interface, an operating system and application programs, which are connected with each other in a commonly known way to perform operation, temporary storage, displaying and data transmission. In an embodiment of the invention, the control device 101 can be a microcontroller unit (MCU). Since the above architecture is generally known, the detailed description is omitted.

In an embodiment of the invention, the vehicle smart device 109 can be built-in or externally connected to the driving and driver behavior information system 100. In one embodiment, the vehicle smart device 109 can be a driving computer of the vehicle, or an interface connected with the driving computer of the vehicle. The sensing signal Sₚᵣₑ, reference signal S_{ref}, Noise signal measured by the sensing device 107a are transmitted to the vehicle smart device 109 to intervene in the driving behavior of the vehicle when there is bad driving behavior or the driver is distracted, or to transmit it to an external terminal (such as driving computer) for further integration or application, for example, active vehicle-distance control, collision prevention, pedestrian detection and warning, moving object detection and warning, so as to improve the overall driving safety when driving.

Referring to FIG. 2, in an embodiment of the invention, the analysis device 105 is installed in a near terminal (in the vehicle) or a cloud platform 300 to cooperate with an insurance evaluation system 313 in the cloud platform 300 for application. An analysis device 305 is configured in the cloud platform 300. In this embodiment, the control device 101 can establish a connection with the cloud platform 300 through a communication network and Internet by coupling with the wireless base station through the above network communication interface, and the sensing signal Sₚᵣₑ, reference signal S_{ref}, Noise signal and driver's behavior signal S_{dr} are digitally encoded and compressed, and then transmitting to the analysis device 305. If a traffic accident occurs, it can be supported or compared with the analysis results output by the cloud platform 300 and provided to the insurance evaluation system 313 for further evaluation of the insurance business required. such as financial lending or trading, fleet management, behavioral vehicle insurance, and insurance formulated based on customer usage or driving style, and the resume of the vehicle, driving or driver is stored in a storage device (driving behavior record device) 303. Referring to FIG. 2, it should be noted that the analysis device 305 (105) and the storage device 303 (103) to store driving behavior can be deployed at the far end of the driving and driver behavior information system 100, such as the cloud platform 300, or at the near end, such as carried by a vehicle.

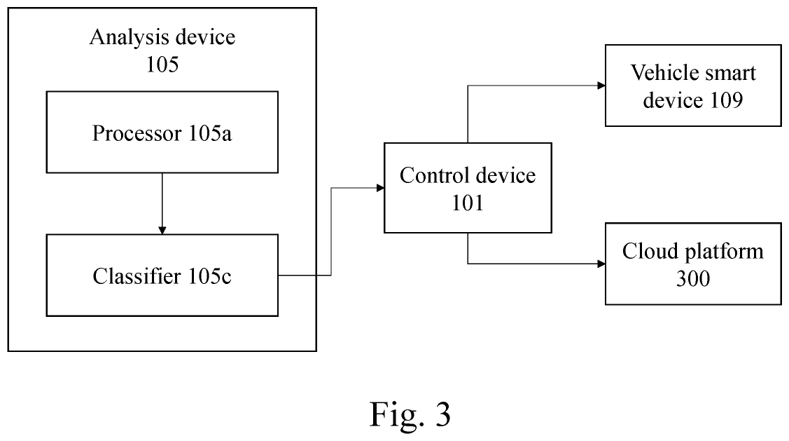

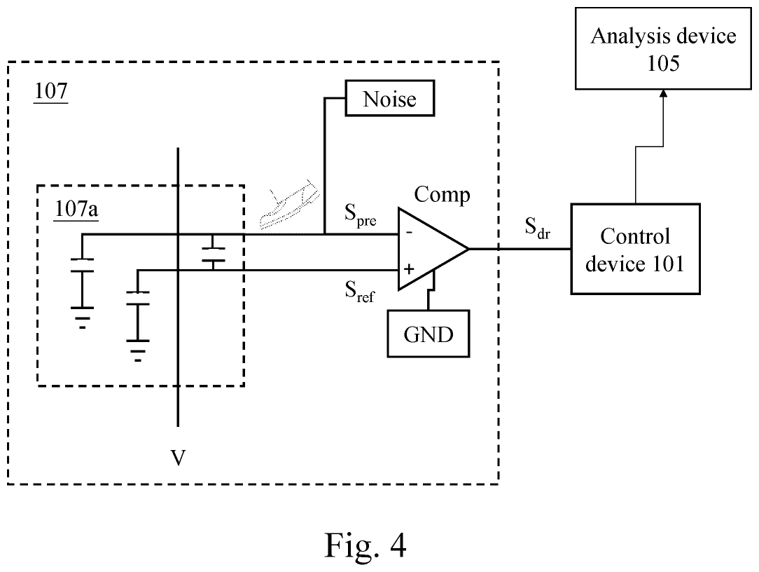

Referring to FIG. 3-4, the analysis device 105 includes a data processor 105a to establish an analysis mode or model of driving behavior based on the relationship between the intensity of driving behavior signal S_{dr} and time. In FIG. 4, it illustrates a diagram of signal transmission in an embodiment of the present invention, wherein the senor 107a installed in the vehicle control part 107 transmits the received sensing signal including the sensing signal Sₚᵣₑ, reference signal S_{ref}, Noise signal and driver's behavior signal S_{dr} to the data processor 105a of the analysis device 105. As the sensing device 107a is a capacitive pressure gauge, when the change of pressure applied by the driver is detected, it will cause the deformation of the sensing device 107a to change the electrostatic capacity under the constant supply voltage V. The change of electrostatic capacity will be converted into an electronic received sensing signal Sₚᵣₑ by the sensing device 107a. After comparing the reference signal S_{ref} and Noise signal by a comparator Comp, the driver's behavior signal S_{dr} is output and transmitted to the data processor 105a for data processing through the control device 101. In an embodiment of the invention, the driver's behavior signal S_{dr} and pressure can be mapped by data processing of the data processor 105a, and draw the curve of the driver's behavior signal S_{dr} and pressure by a statistical regression line for future application. The pressure applied by the driver to the vehicle control part 107 can be calculated based on the driver's behavior signal S_{dr}.

In view of the above description, it should be noted that data of the received sensing signal Sₚᵣₑ, reference signal S_{ref}, Noise signal and driver's behavior signal S_{dr} can also be transmitted to the system elements required for the application through the function of coordinating the system operation of the control device 101, which is not limited to transmit to the analysis device 105. For example, the above raw data can be independently transmitted to the vehicle smart device 109, or the insurance evaluation system 313 and the storage device 303 of the cloud platform 300, so that the above system elements can choose to directly use the analysis results output by the analysis device 105 (305), or the received sensing signal Sₚᵣₑ, reference signal S_{ref}, Noise signal and driver's behavior signal S_{dr} can be calculated for required by the application as needed. For example, the vehicle smart device 109 can be a vehicle computer which specifically includes the functions of active vehicle-distance control, collision prevention, pedestrian detection and warning, moving object detection and warning, or the functions of fleet management, behavioral vehicle insurance, financial loan or transaction in the insurance evaluation system 313, which can directly use the analysis results output by the analysis device 305, or the raw data as a further application.

According to the content of the invention, the analysis device 105 comprises a classifier 105c, which further classifies the analysis model established by the data processor 105a. In one aspect of the invention, the data processor 105a can determine the pressure applied by the driver to the vehicle control part 107 through the driver's behavior signal S_{dr}. When the driver is faced with different vehicle conditions or road conditions, and even different mental conditions, the pressure will change. Take the holding strength of the driver to the steering wheel 500 as an example, normal driving situations, distracted driving situations, driving situations when overtaking, and driving situations when being forced to drive maliciously will make the pressure (grip strength) on the steering wheel 500 different. Therefore, in an embodiment of the invention, the classifier 105e can classify the application situations in advance, for example, classifying the driver's mental state into: lax, imminent lax, normal, slightly excited, excited, and distinguish the driver's mental state by the strength of the driver's behavior signal S_{dr} in the analysis model established by the data processor 105a. When the driver's behavior signal S_{dr} is in a high probability of traffic accidents, it will be warned and intervened through the vehicle smart device 109 or the cloud platform 300, and its driving behavior will be stored in the storage device 103 (303) for subsequent application.

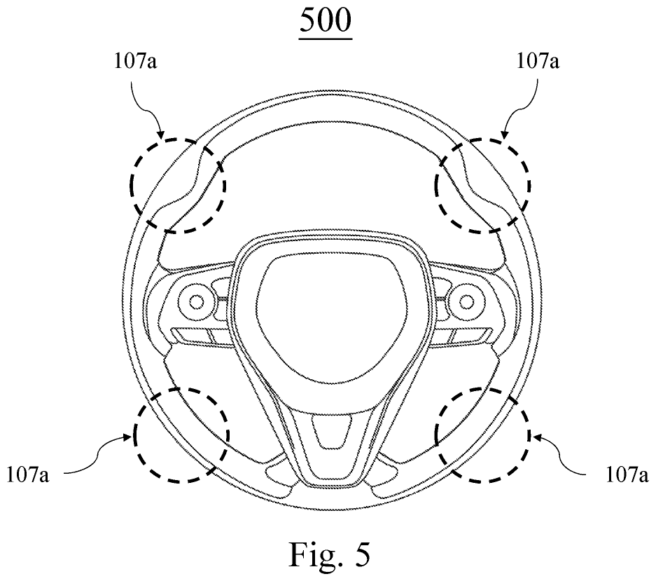

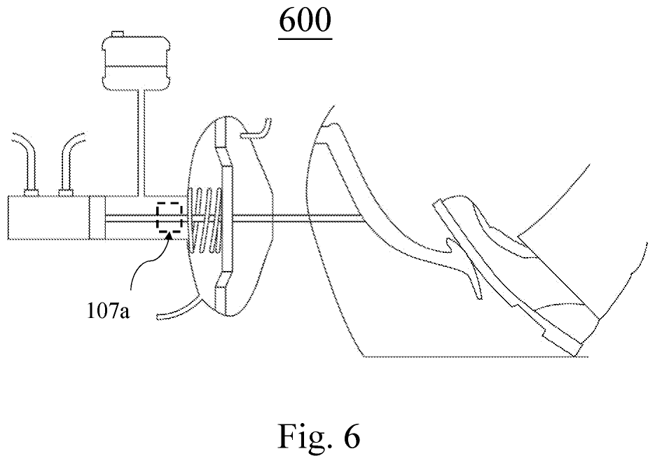

Referring to FIGS. 5-6, they illustrate how the sensing device 107a is applied to the vehicle control part 107. Referring to FIG. 5, in an embodiment of the invention, the vehicle control part 107 can be the steering wheel 500 of a vehicle. In order to enable the sensing device 107a to accurately sense the pressure (grip strength) or position applied by the driver to the steering wheel 500, the sensing devices 107a can be arranged on the upper right (first quadrant), upper left (second quadrant), lower left (third quadrant), and lower right (fourth quadrant). The number of the sensing devices 107a can be decided according to the actual needs of the application, such as N, and N is a natural number greater than 1. In this way, when driving, the driver puts his hand anywhere on the steering wheel 500, it can ensure that the driving and driver behavior information system 100 can truly sense the holding strength and improve the stability and reliability of the system.

In addition, referring to FIG. 6, in another embodiment of the present invention, the vehicle control part 107 can also be a pedal 600 of a vehicle, such as pedal of accelerator, brake, clutch. After in-depth statistical research and the driving experience of ordinary people, the vehicle operation is usually positively correlated with the pedal 600. For example, during intense driving, the driver will frequently control the accelerator pedal and brake pedal. It is relatively gentle during ordinary driving, therefore, when the sensing device 107a is set on the pedal 600, it can follow the change of the driver's behavior signal S_{dr}, to detect foot stepping intensity of the driver, judge his driving behavior through the analysis device 105, warn and intervene through the vehicle smart device 109 or the cloud platform 300 when there is a high probability of traffic accidents, and store his driving behavior in the storage device 103 (303).

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A driving behavior information system, comprising:
a control device;
a plurality of sensing devices configured to at least one vehicle control part, wherein said at least one vehicle control part includes a steering wheel, wherein a pressure or a position of a driver applied on said steering wheel is sensed by at least one said sensing devices;
a vehicle smart device coupled with said control device to collect information; and
an analysis device coupled with said control device to establish a driving behavior model based on said collected information.

2. The system of claim 1, wherein said plurality of sensing devices are capacitive sensing devices.

3. The system of claim 1, wherein said plurality of sensing devices are resistive sensing devices.

4. The system of claim 1, wherein said sensing devices are configured on four quadrants with a center of said steering wheel as an origin.

5. The system of claim 1, wherein said at least one vehicle control part further comprises a pedal, which pressure is sensed by said sensing devices.

6. The system of claim 1, wherein said analysis device includes a classifier to classify said driving behavior model.

7. The system of claim 1, further comprising a storage device to couple with said control device.

8. The system of claim 1, wherein said sensing devices are set in cushion and backrest of a vehicle to detect riding conditions of a driver.

9. The system of claim 1, wherein said analysis device is installed in a cloud platform.

10. The system of claim 1, wherein said analysis device is installed in a vehicle.

11. A driving behavior information system, comprising:
a control device;
a plurality of sensing devices configured to at least one vehicle control part, wherein said at least one vehicle control part includes a steering wheel, wherein a pressure or a position of a driver applied on said steering wheel is sensed by at least one said sensing devices;
a vehicle smart device coupled with said control device to collect information;
an analysis device coupled with said control device to establish a driving behavior model based on said collected information; and
an insurance evaluation system coupled with said control device to evaluate insurance based on said collected information.

12. The system of claim 11, wherein said plurality of sensing devices are capacitive sensing devices.

13. The system of claim 11, wherein said plurality of sensing devices are resistive sensing devices.

14. The system of claim 11, wherein said sensing devices are configured on four quadrants with a center of said steering wheel as an origin.

15. The system of claim 11, wherein said at least one vehicle control part further comprises a pedal, which pressure is sensed by said sensing devices.

16. The system of claim 11, wherein said analysis device includes a classifier to classify said driving behavior model.

17. The system of claim 11, further comprising a storage device to couple with said control device.

18. The system of claim 11, wherein said sensing devices are set in cushion and backrest of a vehicle to detect riding conditions of a driver.

19. The system of claim 11, wherein said analysis device is installed in a cloud platform.

20. The system of claim 11, wherein said analysis device is installed in a vehicle.
